(19) United States
(12) Patent Application Publication
(10) Pub. No.: US 2012/0138169 A1
(43) Pub. Date: Jun. 7, 2012

(54) FUEL TANK VAPORIZATION GAS PURGE SYSTEM

(75) Inventors: Myeonghwan Kim, Hwaseong-si (KR); Buyeol Ryu, Hwaseong-si (KR); Wonkyu Choi, Gunpo-si (KR)

(73) Assignee: Hyundai Motor Company, Seoul (KR)

(21) Appl. No.: 13/227,183

(22) Filed: Sep. 7, 2011

(30) Foreign Application Priority Data
Dec. 6, 2010 (KR) 10-2010-0123774

(51) Int. Cl. F16K 31/02

(52) U.S. Cl. 137/487.5

(57) ABSTRACT

A fuel tank vaporization gas purge system may include a fuel tank with a vent valve and a roll over valve disposed for discharging a vaporization gas, a canister for absorbing/detaching a hydrocarbon in the vaporization gas, a vent line and a sub-vent lines connected to the canister to the vent valve and the roll over valve, a vapor control valve disposed in either the vent line or the sub-vent line, and an electronic control unit (ECU) electrically connected to said vapor control valve and selectively opening/closing said vapor control valve based on a type of said vapor control valve and operating conditions of a vehicle. The vapor control valve may be of an open valve type and closed by the ECU when an engine is in purging, or of a close valve type and opened by the ECU when an engine is turned off or during refueling.

### CROSS-REFERENCE TO RELATED APPLICATIONS

The present application claims priority of Korean Patent Application Number 10-2010-0123774 filed Dec. 6, 2010, the entire contents of which application is incorporated herein for all purposes by this reference.

### BACKGROUND OF INVENTION

1. Field of Invention

The present invention relates to a fuel tank vaporization gas purge system, and more particularly, to a fuel tank vaporization gas purge system that can implement purge efficiency satisfying the vaporization gas rule for hybrid vehicle/plug-in hybrid vehicles (HEV/PHEV) by controlling a valve in a vaporization gas line connected from a fuel tank to a canister.

2. Description of Related Art

In general, vehicles are equipped with a fuel gas vaporization gas purge system, because fuel vaporization gas containing hydrocarbon (HC), which is a contaminant discharged to the atmosphere, is produced from a fuel tank of a vehicle.

The fuel tank vaporization gas purge system prevents hydrocarbon (HC), a contaminant, from being discharged to the atmosphere by collecting vaporization gas from a fuel tank in a canister with charcoal and then sending the collected vaporization gas to a combustion chamber by purging when the engine operates.

With the increase of concern over environmental pollution, a vaporization gas rule that more strongly regulates reduction of toxic substances, such as hydrocarbon (HC) contained in the vaporization gas from vehicles, is in force in North America.

It is necessary to increase purge efficiency of the fuel tank vaporization purge system in order to satisfy the enforced vaporization gas rule.

Although a method of increasing the capacity and efficiency of a canister is used to increase the purge efficiency, this necessarily increases the cost and the weight, because a specific sub-canister is added, other than one main canister.

Further, since the specific sub-canister is used, it is required to change the design of the fuel tank in order to ensure a space for installing the sub-canister and ventilation resistance increased by extension of a fuel vapor system due to the sub-canister.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide a fuel tank vaporization purge system that can satisfy the enforced vaporization gas rule without increasing the capacity of a canister by increasing collection rate and purge efficiency of vaporization gas, through dividing a vaporization gas line connected from a fuel tank to the canister into two lines, and controlling a valve in one line to open/close.

Exemplary fuel tank vaporization gas purge systems of the present invention may include a vent line connected to a vent valve, which is disposed in a fuel tank and discharges vaporization gas, and a canister that collects hydrocarbon (HC) in the vaporization gas and supplies the vaporization gas to an engine in purging, a sub-vent line connected to an roll over valve (ROV) valve discharging the vaporization gas disposed in the fuel tank and the canister, and a vapor control valve disposed in one of the lines and switched to close by an electronic control unit (ECU) when the engine is purged.

An aspect of exemplary fuel tank vaporization gas purge systems may provide that one of the vent line and the sub-vent line is not directly connected to the canister, but connected to the other line.

Another aspect of exemplary fuel tank vaporization gas purge systems may provide that the vent line is directly connected to the canister and the vapor control valve is disposed in the vent line. The sub-vent line is connected to the vent line, between the vapor control valve and the canister.

Still another aspect of exemplary fuel tank vaporization gas purge systems may provide that a heater is disposed at the connecting portion of an air line supplying atmosphere of the canister and controlled by the ECU.

Exemplary fuel tank vaporization gas purge systems of the present invention may also include a vent line connected to a vent valve, which is disposed in a fuel tank and discharges vaporization gas, and a canister that collects hydrocarbon (HC) in the vaporization gas and supplies the vaporization gas to an engine in purging, a sub-vent line connected to an ROV valve discharging the vaporization gas disposed in the fuel tank and the canister, and a vapor control valve disposed in one of the lines and switched to open by an ECU when the engine is turned off or a vehicle is filling with fuel (during refueling).

The vent line is directly connected to canister and the vapor control valve is disposed in the line, the sub-vent line is connected to the vent line, between the vapor control valve and the canister, and a heater that is disposed at the connecting portion of an air line supplying atmosphere and controlled by the ECU is disposed at the canister.

According to the Exemplary fuel tank vaporization gas purge systems of the present invention, it is possible to increase collection rate of vaporization gas of a canister when an engine is turned off or during refueling, and increase purge efficiency of the canister when the engine is turned on, by controlling the opening/closing of a valve disposed in one of two divided vaporization gas lines for a fuel tank and the canister.

Further, according to the Exemplary fuel tank vaporization gas purge systems of the present invention, it is possible to satisfy an enforced vaporization gas rule without increasing capacity of the canister, by largely increasing collection rate and purge efficiency of vaporization gas of the canister by opening/closing the valve.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the configuration of an exemplary fuel tank vaporization gas purge system according to the present invention and illustrating the operation when an engine is turned off or a vehicle is filling with fuel.

FIG. 2 is a view showing the purge operation of the exemplary fuel tank vaporization gas purge system according to the present invention when the engine is turned on.

FIG. 3 is a view showing the configuration of another exemplary fuel tank vaporization gas purge system according to the present invention and illustrating the operation when an engine is turned off or a vehicle is filled with oil.

FIG. 4 is a view showing the purge operation of the other exemplary fuel tank vaporization gas purge system according to the present invention when the engine operates.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

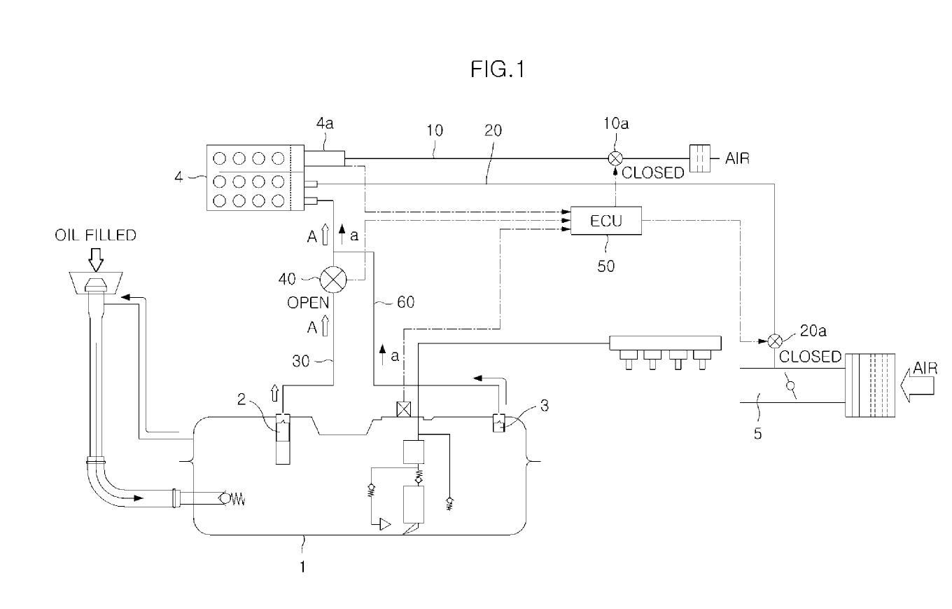

Referring to FIG. 1, a fuel tank vaporization gas purge system includes a fuel tank 1 connected to a fuel inlet, a pair of valves for discharging vaporization gas produced from fuel tank 1, vaporization gas lines connected with the pair of valves, respectively, and converging, a vapor control valve 40 disposed on the vaporization gas line and controlled by an electronic control unit (ECU) 50, a canister 4 absorbing hydrocarbon (HC) in vaporization gas flowing inside through the vaporization gas line with charcoal, and then removing or detaching the hydrocarbon (FTC) and sending it to intake line 5 connected with a purge line 20 in purging, and a heater 4a disposed at the connecting portion of an air line 10 of canister 4 and controlled by ECU 50.

The pair of valves are a vent valve 2 discharging the vaporization gas by opening when a large amount of fuel is in fuel tank 1 and an roll over valve 3 (ROV) discharging the vaporization gas by opening when a small amount of fuel is in fuel tank 1.

Canister 4 may not be equipped with heater 4a in various embodiments of the present invention.

An air control valve 10a that is controlled to open/close by ECU 50 is disposed in air line 10 and a purge control valve 20a that is controlled to open/close by ECU 50 is disposed in purge line 20.

The vaporization gas line is composed of a vent line 30 directly connected from vent valve 2 to canister 4 and a sub-vent line 60 connected from ROV valve 3 to vent line 30.

Vapor control valve 40 is disposed in vent line 30, between the front end of vent valve 2 and the rear end of canister 4 and sub-vent line 60 is connected to vent line 30, between the front end of vapor control valve 40 and the rear end of canister 4.

Vapor control valve 40 is an open valve or open-type valve, which is biased open, and is switched to close by ECU 50 in purging, in various embodiments of the present invention. Vapor valve 40 is of a solenoid type.

Therefore, according to various embodiments of the present invention having the configuration shown in FIG. 1, the vaporization gas in fuel tank 1 is discharged to canister 4 through vent line 30 and sub-vent line 60 when the engine is turned off or the vehicle is filled with oil.

That is, referring to FIG. 1, as the vaporization gas produced from fuel tank 1 flows into vent line 30 through vent valve 2, the flow (A) of the vaporization gas goes to canister 4 through vapor control valve 40 that keeps open.

Further, the vaporization gas produced from fuel tank 1 and flowing out through ROV valve 3 flows into sub-vent line 60 and the flow (a) of the vaporization gas goes to vent line 30 connected to sub-vent line 60 after vapor control valve 40.

As the vaporization gas produced from fuel tank 1 is discharged to canister 4 by the vaporization gas flow (A) passing through vent valve 2, vent line 30, and vapor control valve 40 and the vaporization gas flow (a) passing through ROV valve 3, sub-vent line 60, and vent line 30, the efficiency of collecting vaporization gas of canister 4 when the engine is turned off or the vehicle is filling with fuel can be considerably increased.

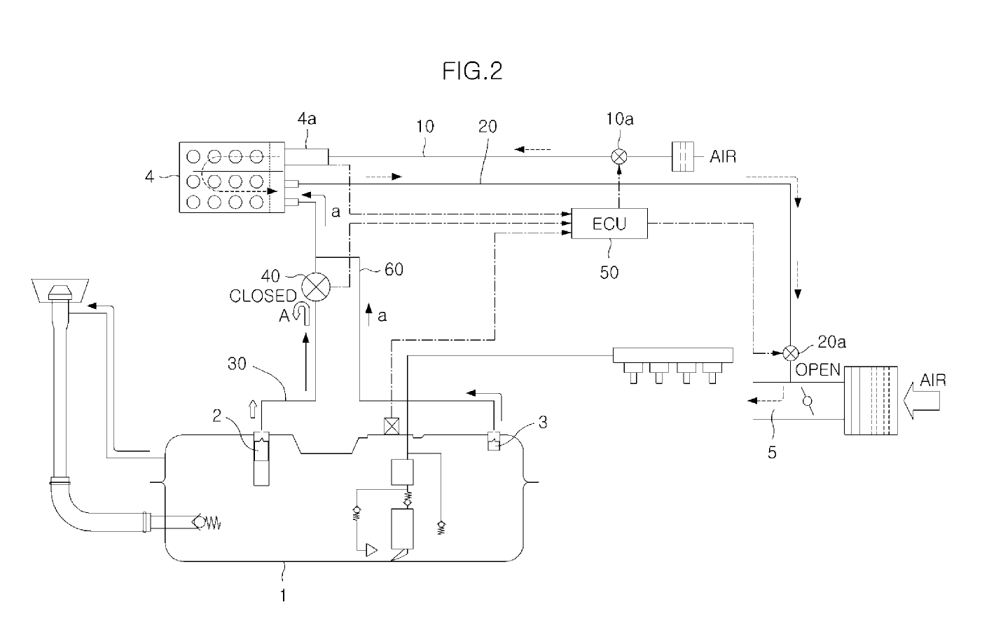

FIG. 2 is a view showing the purge operation of the fuel tank vaporization gas purge system according to various embodiments of the present invention when the engine is turned on.

As the canister is purged with the start of the engine, ECU 50 heats heater 4a at the canister 4 and almost simultaneously opens air control valve 10a in air line 10 and purge control valve 20a in purge line 20.

In this process, vapor control valve 40 in vent line 30 is controlled to close by ECU 50.

Accordingly, the temperature of charcoal is increased and removal efficiency of hydrocarbon (HC) is substantially increased by inflow of air heated by heater 4a in canister 4 while the vaporization gas in fuel tank 1 passes through sub-vent line 60 connected to ROV valve 3 and flows into canister 4 through vent line 30 after vapor control valve 40, and then passes through purge line 20.

As described above, as the vaporization gas in fuel tank 1 is supplied to canister 4 through sub-vent line 60 connected to ROV valve 3, the purge efficiency of canister 4, which implements the optimum purge efficiency when only pure air flows inside from the atmosphere, is necessarily decreased.

However, the amount of vaporization gas flowing to sub-vent line 60 through ROV valve 3 is smaller than the amount of vaporization gas passing through vent valve 2, such that it is possible to have advantages outweighting small reduction of purge efficiency of canister 4.

That is, the internal pressure of fuel tank 1 can be prevented from excessively fitting to the negative pressure condition and increasing generation of vaporization gas, when a small amount of vaporization gas passing out through ROV valve 3 from fuel tank 3, as compared with when the vaporization gas can never passes out.

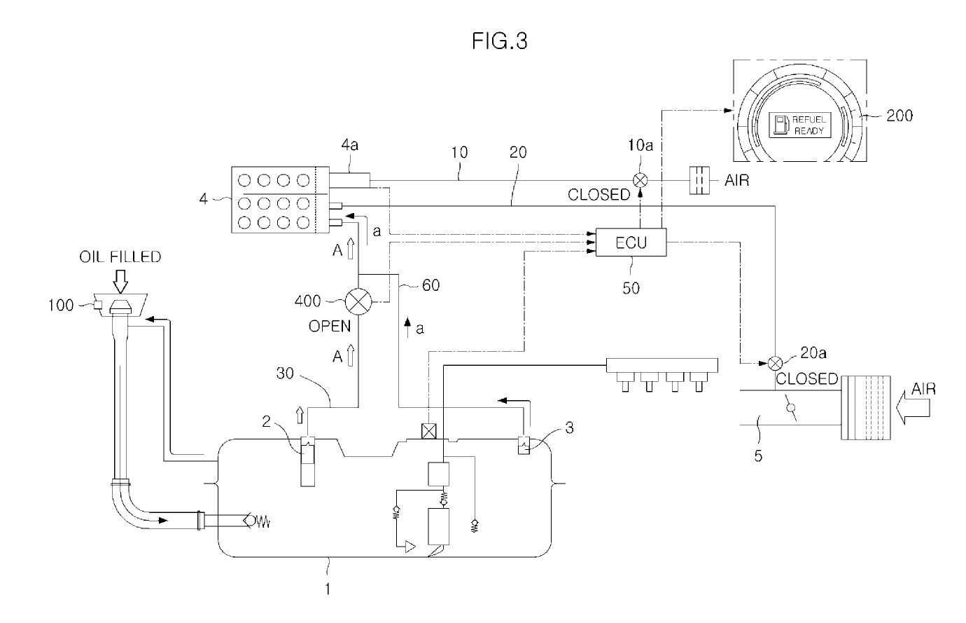

FIG. 3 is a view showing the configuration of the fuel tank vaporization gas purge system according to various embodiments of the present invention.

The exemplary embodiment illustrated in FIG. 3 differs from above-described exemplary embodiment in that the operational type of vapor control valve 400 disposed in vent line 30 directly connected from vent valve 2 to canister 4. ECU 50 is designed to sense a signal of a filler lid switch 100 disposed at the fuel inlet of fuel tank 1, due to the difference in operational type of vapor control valve 400.

That is, vapor control valve 400 according to various embodiments of the present invention is a closed valve or closed-type valve, which is biased closed, and is switched to open by ECU 50 when the engine is turned off or the vehicle is filling with fuel (during refueling). Vapor valve 400 is of a solenoid type.

ECU 50 provides a driver with information on filler lid-open and fuel-filling possibility by sending a control signal to fuel-filling cluster 200 when sensing a signal of filler lid switch 100.

FIG. 3 shows the operation of the fuel tank vaporization gas purge system according to various embodiments of the present invention, when the engine is turned off or the vehicle is filling with fuel.

As shown in the figure, in various embodiments, when ECU 50 senses that the engine is turned off or the vehicle is filling with fuel in response to a signal of filler lid switch 100 at the fuel inlet, vapor control valve 400 is switched to open.

As vapor control valve 400 is switched to open, in various embodiments, similar to the above-described exemplary embodiment, the vaporization gas of fuel tank 1 is charged to canister 4 through vent line 30 and sub-vent line 60.

Therefore, in various embodiments, as the vaporization gas produced from fuel tank 1 is almost simultaneously supplied to canister 4 by the vaporization gas flow (A) passing through vent valve 2, vent line 30, and vapor control valve 400 and the vaporization gas flow (a) passing through ROV valve 3, sub-vent line 60, and vent line 30, the efficiency of collecting vaporization gas of canister 4 when the engine is turned off or the vehicle is filling with fuel can be considerably increased.

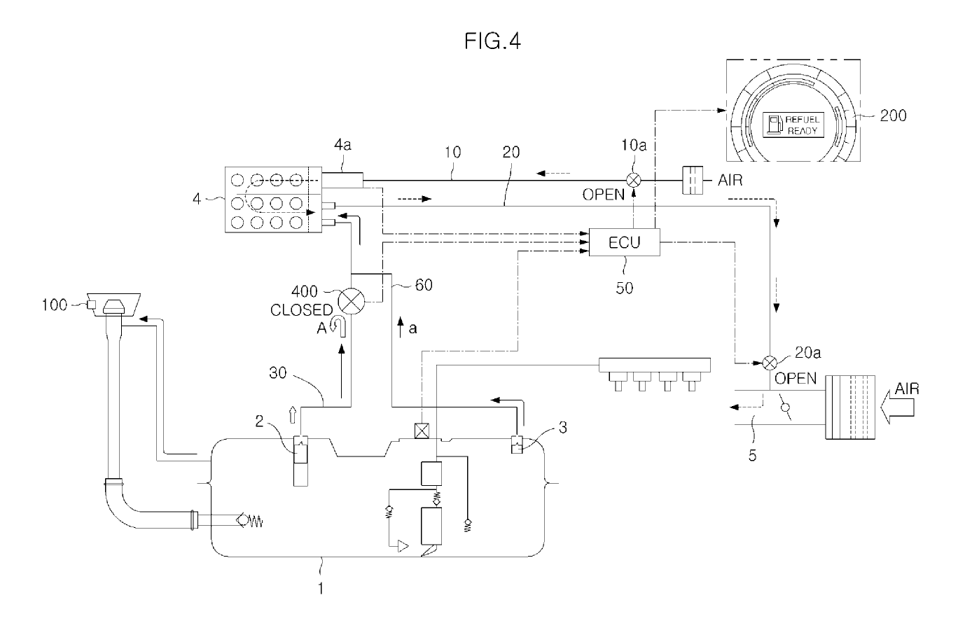

FIG. 4 is a view showing the purge operation of the fuel tank vaporization gas purge system according to various embodiments of the present invention when the engine starts.

As shown in the figure, as the canister is purged with the start of the engine, ECU 50 heats heater 4a at the canister 4 and simultaneously opens air control valve 10a in air line 10 and purge control valve 20a in purge line 20.

Vapor control valve 400 in vent line 30 keeps closed, the same as the initial state.

In the purging, the temperature of charcoal is increased and removal efficiency of hydrocarbon (HC) is largely increased by inflow of air heated by heater 4a in canister 4 while the vaporization gas in fuel tank 1 passes through sub-vent line 60 connected to ROV valve 3 and flows into canister 4 through vent line 30 after vapor control valve 40, and then passes through purge line 20.

As described above, as the vaporization gas in fuel tank 1 is supplied to canister 4 through sub-vent line 60 connected to ROV valve 3, the purge efficiency of canister 4, which implements the optimum purge efficiency when only pure air flows inside from the atmosphere, is necessarily decreased.

However, the amount of vaporization gas passing sub-vent line 60 through ROV valve 3 is smaller than the amount of vaporization gas passing through vent valve 2. Therefore, other embodiments can have the same advantages as the above mentioned embodiments, which outweight the reduction of the small purge efficiency of canister 4.

That is, the internal pressure of fuel tank 1 can be prevented from excessively fitting to the negative pressure condition and increasing generation of vaporization gas, when a small amount of vaporization gas passes out through ROV valve 3 from fuel tank 3, as compared with when the vaporization gas can never passes out.

As described above, according to various embodiments of the present invention, since ordinary opened type of vapor control valve 40 or ordinary closed type of vapor control valve 400 is disposed in vent line 30 connected from vent valve 2 to canister 4 and vapor control valves 40 and 400 are controlled to open/close by ECU 50 when the engine is turned off or the vehicle is filling with fuel, it is possible to satisfy the enforced vaporization gas rule, using improved collection rate and purge efficiency of vaporization gas, without increasing the capacity of canister 4.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. A fuel tank vaporization gas purge system, comprising:
a fuel tank with a fuel inlet, a vent valve and a roll over valve (ROV) disposed in said fuel tank, wherein the vent valve and the ROV valve for discharging a vaporization gas, and the fuel inlet for filling a fuel;
a canister absorbing/detaching a hydrocarbon in the vaporization gas;
a vent line connected to the vent valve and the canister;
a sub-vent line connected to the ROV valve and the canister;
a vapor control valve disposed in either the vent line or the sub-vent line; and
an electronic control unit (ECU) electrically connected to said vapor control valve and selectively opening/closing said vapor control valve based on a type of said vapor control valve and operating conditions of a vehicle.

2. The fuel tank vaporization gas purge system as defined in claim 1, wherein the vapor control valve is an opened valve and closed by the ECU when an engine of the vehicle is in purging, or a closed valve and opened by the ECU when an engine is turned off or the vehicle is filling with the fuel.

3. The fuel tank vaporization gas purge system as defined in claim 2, wherein one of the vent line and the sub-vent line is not directly connected to the canister, but connected to the other line.

4. The fuel tank vaporization gas purge system as defined in claim 3, wherein the vent line is directly connected to the canister and the vapor control valve is disposed in the vent line.

5. The fuel tank vaporization gas purge system as defined in claim 4, wherein the sub-vent line is connected to the vent line between the vapor control valve and the canister.

6. The fuel tank vaporization gas purge system as defined in claim 2, further comprising:
a filler lid switch disposed at the fuel inlet and electrically connected to the ECU; and
a fuel-filling cluster electrically connected to the ECU to provide information on operating statuses of the filler lid switch.

7. The fuel tank vaporization gas purge system as defined in claim 1, wherein a heater is disposed at the canister and electrically connected to and controlled by the ECU to increase a removal efficiency of the hydrocarbon.
